(19) United States
(12) Patent Application Publication
(10) Pub. No.: US 2003/0226805 A1
(43) Pub. Date: Dec. 11, 2003

(54) Method of wastewater treatment with biological active carbon using recycled oxygen-enriched water and apparatus used therein

(75) Inventors: Pen-Hsien Chi, Hsinchu (TW); Zhi-Jian Chen, Hsinchu (TW); Wen-Ching Chen, Hsinchu (TW); Rung-Yaw Chen, Hsinchu (TW); Chie Chien Tseng, Hsinchu (TW)

Correspondence Address: BACON & THOMAS, 4th Floor, 625 Slaters Lane, Alexandria, VA, 22314, US

(73) Assignee: Industrial Technology Research Institute, Hsinchu (TW)

(21) Appl. No.: 10/162,668

(22) Filed: Jun. 6, 2002

(51) Int. Cl. C02F 3/00

(52) U.S. Cl. 210/617; 210/151

(57) ABSTRACT

The wastewater treatment method of the present invention includes introducing an influent water to an oxygen-supply tank for aeration; introducing the oxygen-enriched water from the oxygen-supply tank into the bottom of an activated carbon tank, so that the oxygen-enriched water flows upward and expands the activated carbon bed. When the oxygen-enriched water flows through the activated carbon bed, the microorganisms on the activated carbon particles use the enhanced oxygen concentration to decompose the contaminants, such as COD, BOD, TKN, etc., that are contained in the water or adsorbed on the activated carbon particles. Most of the supernatant liquid in the activated carbon tank is recycled to the oxygen-supply tank for aeration, and a small amount of the liquid is discharged, thereby performing a suitable treatment on wastewater having various qualities by controlling the amount of oxygen supply in the oxygen-supply tank and the recycle ratio of (the oxygen-enriched water)/(the influent water).

### FIELD OF THE INVENTION

The present invention relates to a method of wastewater treatment with biological activated carbon using recycled oxygen-enriched water, and an apparatus used therein. The treated wastewater, prior to being discharged, is recycled from an oxygen-supply unit to a biological activated carbon unit so that a sufficient amount of oxygen is provided to the microorganisms on the activated carbon, thereby removing the contaminants, such as COD, BOD and TKN, that are contained in the water/wastewater. The present invention can be applied on the secondary treatment or advanced treatment of wastewater, the advanced treatment for removal of carcinogens precursor, such as trihalomethane, from drinking water. The present invention can also be used together with an ozone system for pretreatment.

### BACKGROUND OF THE INVENTION

In order to achieve an objective of final water purification in a wastewater/sewage treatment, currently industry uses an activated carbon adsorption unit after the conventional biological treatment system for the removal of residual contaminants, such as COD, BOD, TKN, etc. However, the conventional activated carbon adsorption unit used will lose its function in the removal of contaminants due to saturation in adsorption; and the activated carbon needs to be replaced or regenerated in order to maintain its original performance. As a result, the operation manpower and cost will be increased, and the discarded activated carbon needs further treatments, thereby increasing its operation cost. In recent years, a biological activated carbon treatment technology has been developed which includes seeding appropriate microorganisms on the activated carbon. Such that, the activated carbon not only can maintain its conventional adsorption power, but also exhibit a function of biological decomposition removal. The researches indicate that, for organic wastewater with a given concentration, the use of a biological activated carbon can prolong the saturation time of the activated carbon for 5-10 times (depending on the type and concentration of the wastewater). This indicates that a biological activated carbon has a wide range of application in the advanced treatment of wastewater/sewage. A sufficient supply of oxygen is necessary for the microorganisms on the activated carbon to effectively decompose the contaminants in the influent water. At room temperature, the saturation oxygen concentration in water is about 8 mg/L. That is, in the conventional fixed-bed biological activated carbon system, by allowing wastewater flowing through the biological activated carbon bed without an additional supply of oxygen, the COD concentration that can be removed biologically can only reach 8 mg/L at most. Besides the treatment of water having a very low concentration of COD, such a system has a very limited range of application. If the COD of an influent wastewater reaches 200 mg/L, the treatment needs to be repeated for more than 13 times in order to gradually reduce the contamination concentration to a discharge standard of less than COD 100 mg/L which was stipulated by The Republic Of China On Taiwan in 1998. This will greatly increase the volume of reactors and is not practical. In order to improve this defect, conventionally a continuous aeration is used to maintain enough DO concentration in a biological activated carbon tank so that the removal of contaminants can be increased. Moreover, in order to obtain sufficient DO concentration, and a mixing (fluidization) of the activated carbon for enhancing the contact of organic materials with oxygen, a sufficient kinetic power must be provided by the inlet air. However, a vigorous air flow will generate a larger shear stress and cause the particles of activated carbon to rupture and lose. As a result, the activated carbon needs to be replenished from time to time, and the concentration of suspended solids (SS) in the discharged water increases. On the other hand, in a biological activated carbon treatment system using this type of fluidized bed, the filling ratio of activated carbon can not be too high (4˜10 volume %). In order to maintain a certain degree of the removal of contaminants, the total amount of activated carbon must be maintained above a specific amount, thereby increasing the total volume of the reactor. Furthermore, the reactor must be maintained above a certain height or width for the installation of a sedimentation tank. Otherwise, the fluidized activated carbon will float out of the tank. The increase in volume and height will increase the capital cost, and it is rather disadvantageous.

### SUMMARY OF THE INVENTION

The main objective of the present invention is to provide a novel biological activated carbon wastewater treatment technology to improve the defects of the conventional technology, so that the invented technology can be more efficient and have a higher economic value than the conventional technology.

In order to achieve the abovementioned objective, a method of wastewater treatment using biological activated carbon with recycled oxygen-enriched water according to the present invention comprises the following steps:

a) introducing a to-be-treated wastewater into an oxygen supply tank, where an aeration with air or an oxygen-enriched gas is carried out, so that an oxygen-enriched water is formed;

b) introducing the oxygen-enriched wastewater from Step (a) into a bottom of a reactor containing a biological activated carbon bed, so that said biological activated carbon bed is expanded and a treated wastewater is formed in an upper portion of the reactor;

c) filtering and discharging a portion of the treated wastewater, and recycling another portion of the treated wastewater to said oxygen supply tank for performing aeration with said to-be-treated wastewater.

Another method of wastewater treatment using biological activated carbon with a recycled oxygen-enriched water according to the present invention comprises the following steps:

a) introducing a to-be-treated wastewater into an upper portion of a reactor containing a biological activated carbon bed, where the to-be-treated wastewater is mixed with a treated wastewater in said reactor;

b) introducing the mixed water from the upper portion of the reactor in Step (a) into an oxygen supply tank for aeration with air or an oxygen-enriched gas, so that an oxygen-enriched water is formed in the oxygen supply tank;

c) filtering and discharging a portion of the oxygen-enriched water in the oxygen supply tank, and recycling another portion of the oxygen-enriched water in the oxygen supply tank to a bottom of said reactor, so that said biological activated carbon bed is expanded.

In the invented methods, the flow rate of the discharged water is substantially equal to the flow rate of the inflow of the to-be-treated wastewater such that the operation is kept at a steady state.

In the invented methods, the ratio of the flow rate of the recycled flow to the flow rate of the to-be-treated wastewater can be adjusted according to the quality of the to-be-treated wastewater and generally is between 8-30.

In the invented methods, the biological activated carbon bed in the reactor is supported at a location which is of a distance from the bottom of the reactor, and the recycle is introduced into said reactor at a location between the bottom of said reactor and said support location.

A wastewater treatment apparatus using biological activated carbon with a recycled oxygen-enriched water suitable for the present invention comprises two sets of units, wherein one set is a biological activated carbon unit and another set is an oxygen supply unit; and a recycle means. Wherein said biological activated carbon unit comprises: a tank as a reactor, the interior of which, in the order from the bottom thereof, being installed with a distribution pipe, a support material and a water collection overflow means, wherein an activated carbon can be disposed between said support material and said water collection overflow means. Said oxygen supply unit comprises: an oxygen supply tank and an aeration means. Said aeration means introduces air or an oxygen-enriched gas into said oxygen supply tank. Said water collection overflow means introduces a liquid from the reactor into the oxygen supply tank; and said recycle means supplies an aerated liquid in the oxygen supply tank to the distribution pipe of the reactor.

There are two types of connections between said biological activated carbon unit and said oxygen supply unit. They are (1) a combined type: the reactor of said biological activated carbon unit is connected to the oxygen supply tank of said oxygen supply unit, i.e. the two units share a common wall, wherein an appropriate hole is provided on the common wall of the two units near said water collection overflow means so that water/wastewater can smoothly flow into said oxygen supply tank from said biological activated carbon unit, preferably a baffle plate is installed in the hole to prevent the water inside said oxygen supply tank from back flowing to said biological activated carbon unit; and (2) a separation type: the reactor of said biological activated carbon unit and the oxygen supply tank of said oxygen supply unit are installed separately, wherein a pipeline connects the reactor wall of said biological activated carbon unit near said water collection overflow means to the oxygen supply tank of said oxygen supply unit, so that a liquid inside said reactor is discharged and flows into said oxygen supply tank. Preferably said oxygen supply unit is lower than said activated carbon unit such that the liquid inside said reactor is discharged and flows into said oxygen supply tank without an additional power.

Said aeration means suitable for the present invention comprises a set of aeration heads installed inside said oxygen supply tank, and a blower or an air compressor installed outside said oxygen supply tank, wherein air or an oxygen-enriched gas is supplied to said aeration heads by said blower or air compressor, and distributed into said oxygen supply tank. Alternatively, a submerged type aeration machine installed inside said oxygen supply tank can be used.

Said recycle means suitable for the present invention comprises a recycle pipeline connecting the interior of said oxygen supply tank to said distribution pipe in the reactor; and a land-type or submerged-type pump provided on the recycle pipeline.

Preferably, the wastewater treatment apparatus of the present invention further comprises a filter for filtering the water discharged from the oxygen supply tank or the reactor.

Still another method of wastewater treatment using biological activated carbon with recycled oxygen-enriched water according to the present invention comprises the following steps:

a) introducing a to-be-treated wastewater into a metering tank to mix with an oxygen-enriched water, and introducing the resulting mixed water into a bottom of a reactor containing a biological activated carbon bed by gravity, so that said biological activated carbon bed is expanded and a treated wastewater is formed in an upper portion of the reactor after the oxygen contained therein being consumed by microorganisms adsorbed on said biological activated carbon;

b) filtering and discharging a portion of the treated wastewater from Step (a), and recycling another portion of the treated wastewater from Step (a) to an oxygen supply tank having an air-lift tube, wherein said air-lift tube is connected to said metering tank at an upper end thereof; and

c) pumping air or an oxygen-containing gas into a bottom end of said air-lift tube, so that said oxygen-enriched water is formed in said air-lift tube and lifted into said metering tank.

Preferably, said reactor has an annular construction having an inner wall and an outer wall, and said biological activated carbon bed is packed between said inner wall and said outer wall and near the bottom of said annular construction. Further said oxygen supply tank is located at a position confined by said inner wall of said annular construction of said reactor, and preferably, said oxygen supply tank is formed with said inner wall. More preferably, said inner wall has a height lower than that of said outer wall of said annular construction.

The present invention has the following advantages: (1) increasing the efficiency of treatment by using a recycled oxygen-enriched water to increase the DO concentration in water and the removal efficiency of contaminants; (2) decreasing the consumption of activated carbon: flowing the oxygen-enriched water from the bottom of the activated carbon bed upward to slightly expand the activated carbon bed, and thus reduces the friction and wearing among particles; (3) without the need of installing a pretreatment facility: due to the activated carbon bed being in a expanded state, voids between particles will not be clogged by suspended solids, thereby allowing a direct inflow of the water/wastewater after the treatment in a sedimentation tank without the need of installing a pre-filtration treatment facility; (4) reducing the installation height of the units: adopting an oxygen-enriched water reflux to supply oxygen and expand the activated carbon layer instead of using an air-lifting pipe type, thereby reducing the height of units; and (5) increasing the packing ratio of activated carbon: the activated carbon being lifted not by an air-lifting pipe, thereby increasing the packing ratio to 60%.

### BRIEF DESCRIPTION OF THE DRAWINGS

FIGS. 1A, 1B and 1C are block diagrams showing flowcharts of a first, second and third embodiments of the wastewater treatment methods using biological activated carbon with a recycled oxygen-enriched water according to the present invention, respectively.

FIG. 2 shows a schematic plan top view of a wastewater treatment apparatus (combined type) according to the first embodiment of the present invention.

FIG. 2A is a schematic diagram of the cross-section along the line A-A in FIG. 2.

FIG. 3 shows a schematic plan top view of a wastewater treatment apparatus (separated type) according to the second embodiment of the present invention.

FIG. 3A is a schematic diagram of the cross-section along the line A-A in FIG. 3.

FIG. 4 shows a schematic cross-section view of a wastewater treatment apparatus (air-lift type) according to the third embodiment of the present invention.

### LEGENDS

1. oxygen supply tank; 1′. metering tank

2. biological activated carbon reactor

3. recycle pump

4. blower

5. air diffuser

6. distribution pipe

7. water collection overflow weir/trough

8. baffle (combined type); 8′. water recycle pipe (separated type)

9. support material

10. activated carbon bed

11. inlet pipe

12. outlet pipe

13. waste activated carbon discharge pipe

14. air pipe

15. oxygen-enriched water recycle pipe

16, 17. drain valve

18. air regulating valve

19. air-lift tube

### DETAILED DESCRIPTION OF THE PREFERRED EMBODIMENTS

1. Treatment Apparatus Using Biological Activated Carbon with a Recycled Oxygen-Enriched Water (Combined Type)

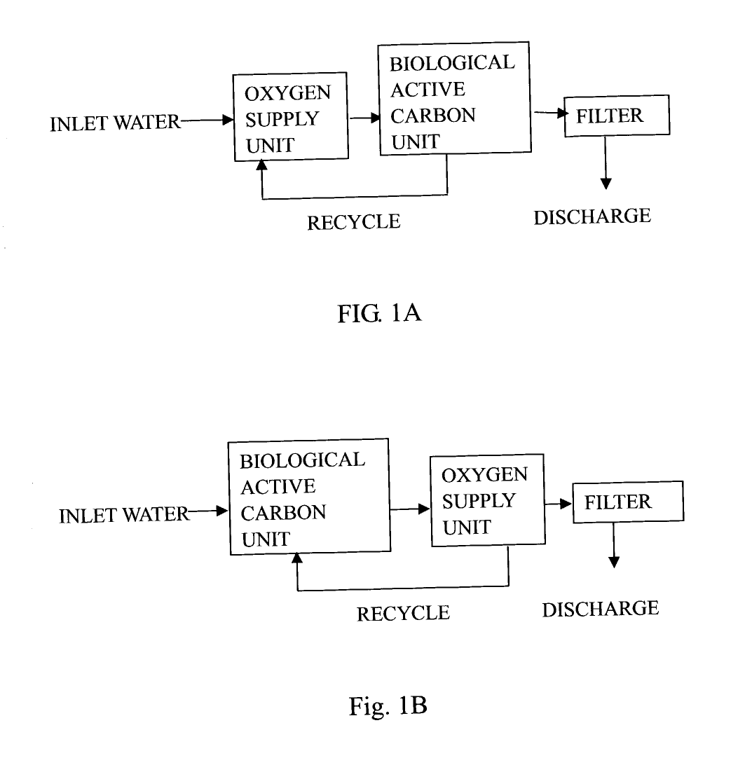

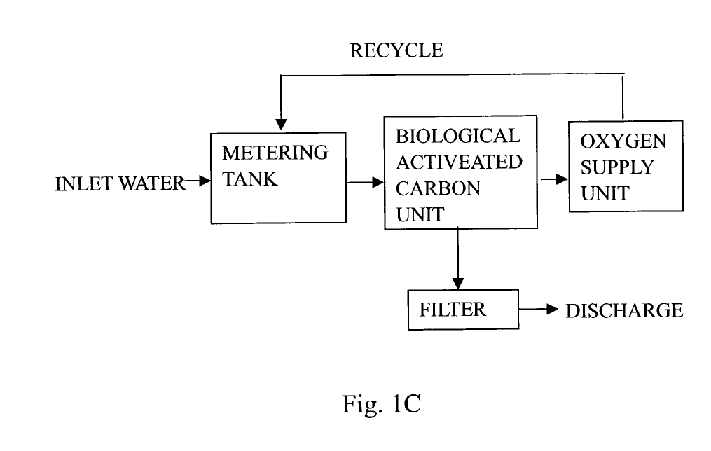

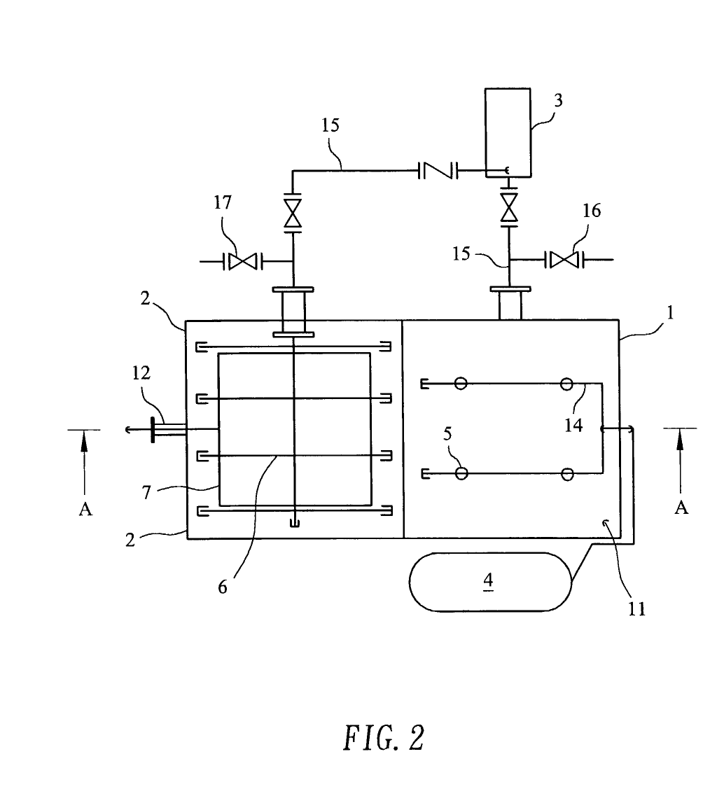

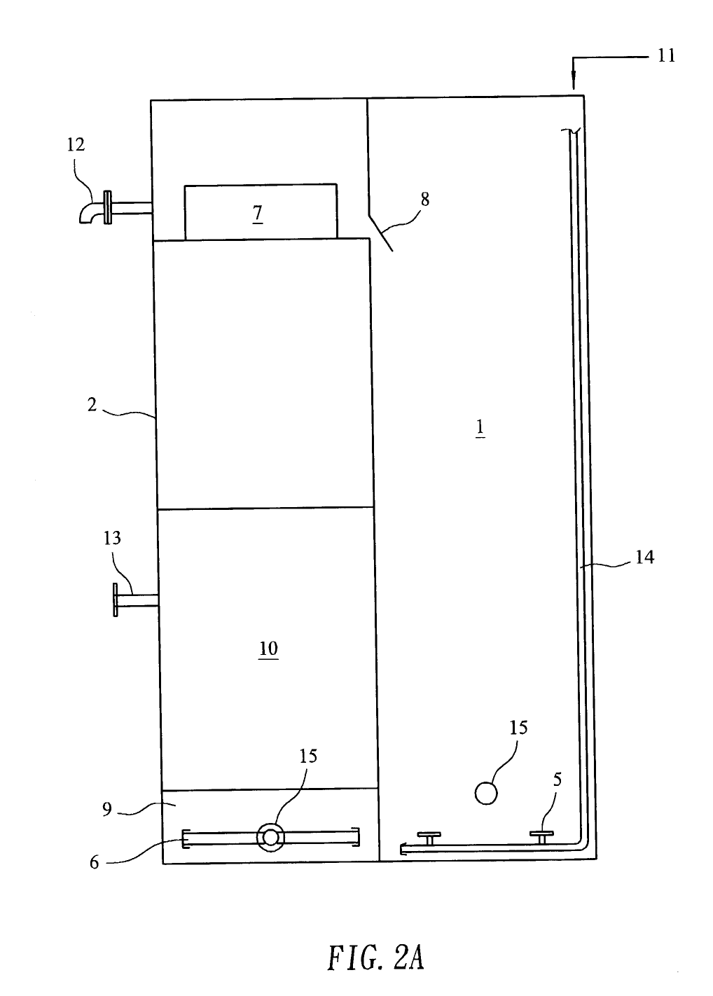

Referring to FIG. 1A and FIG. 2, the processing procedures for a treatment apparatus using biological activated carbon with a recycled oxygen-enriched water according to the present invention comprises: feeding water/wastewater from an inlet pipe 11 to an oxygen supply tank 1; providing air from an air pipe 14 into the oxygen supply tank through air diffusers 5 by a blower 4 for supplying a sufficient amount of oxygen to be dissolved in the water/wastewater in the oxygen supply tank; using a recycle pump 3 to deliver the water/wastewater containing a sufficient amount of oxygen in the tank 1 through a recycle pipe 15 to a biological activated carbon reactor 2; using a distribution pipe 6 at the bottom of the reactor to uniformly distribute the water, which flows upwards through a support material 9 to expand the activated carbon bed 10, wherein the DO contained in the water/wastewater is used by the microorganisms attached on the activated carbon particles or suspended in the water for decomposing the organic contaminants adsorbed on the activated carbon or in the water; controlling the amount of recycle water to expand the activated carbon while not flushing out the activated carbon particles; collecting the treated water through a water collection overflow weir/trough 7; discharging a small portion of the treated water through an outlet pipe 12 to a filter unit (not shown in the figures) for filtering out the suspended solids and discharging the filtered water; recycling a majority of the treated water through an opening connecting the reactor 2 and the tank 1 to the oxygen supply tank 1; obtaining a replenishment of dissolved oxygen in the recycled water from the distribution head 5 and continuing the abovementioned steps. A baffle 8 is provided at the dividing wall of the reactor 2 and the tank 1 for preventing the raw water/wastewater in the tank 1 from flowing back to the overflow weir/trough 7 via the opening. The exhausted activated carbon can be discharged from an outlet pipe 13 for waste activated carbon. The discharge amount of the waste activated carbon shall be determined experimentally. The amount of oxygen required in the removal of contaminants by the biological activated carbon can be adjusted by the amount of oxygen supplied by the blower and the recycle ratio of the oxygen-enriched water to the fed water/wastewater. The water can be separately discharged from the drain valve 16 or 17 when the water contained in the oxygen supply tank 1 or the biological activated carbon reactor 2 needs to be emptied.

2. Treatment Apparatus Using Biological Activated Carbon with a Recycled Oxygen-Enriched Water (Separated Type)

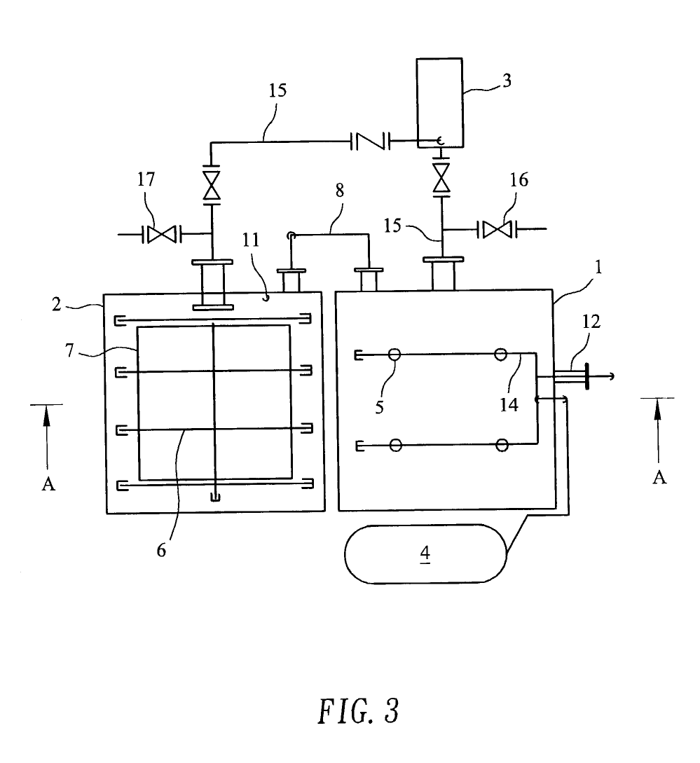

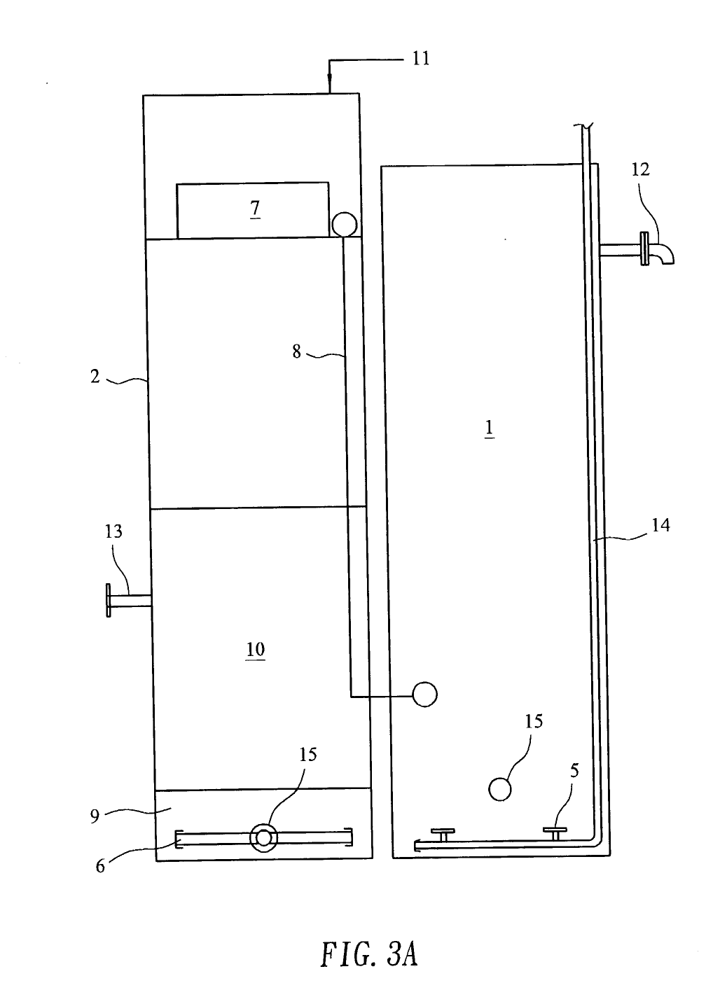

Referring to FIG. 1B and FIG. 3, the processing procedures for another treatment apparatus using biological activated carbon with a recycled oxygen-enriched water according to the present invention comprises: feeding water/wastewater from an inlet pipe 11 to a biological activated carbon reactor 2; providing air from an air pipe 14 into an oxygen supply tank 1 by a blower 4 via air diffusers 5 for supplying a sufficient amount of oxygen to be dissolved in water; using a recycle pump 3 to deliver the water/wastewater containing a sufficient amount of oxygen in the tank 1 to the biological activated carbon reactor 2 via a recycle pipe 15; using a distribution pipe 6 at the bottom of the reactor 2 to uniformly distribute the water, which flow upwards through a support material 9 to expand the activated carbon bed 10, wherein the oxygen contained in the water/wastewater is used by the microorganisms attached on the activated carbon particles or suspended in the water for decomposing the organic contaminants adsorbed on the activated carbon or in the water; controlling the amount of recycle water to expand the activated carbon while not flushing out the activated carbon particles; collecting the treated water through a water collection overflow weir/trough 7, where the collected water is mixed with the water/wastewater entering the reactor 2 from the inlet pipe 11; recycling the mixed water through a recycle pipe 8 to the oxygen supply tank 1; obtaining a replenishment of dissolved oxygen in the recycled water from the distribution head 5 and continuing the abovementioned steps, while discharging a small portion of the water in the upper portion of the tank 1 through an outlet pipe 12 to a filter unit (not shown in the figures) for filtering out the suspended solids and discharging the filtered water. The exhausted activated carbon can be discharged from an outlet pipe 13 of waste activated carbon. The discharge amount of the waste activated carbon shall be determined experimentally. The amount of oxygen required in the removal of contaminants by the biological activated carbon can be adjusted by the amount of oxygen supplied by the blower and the recycle ratio of the oxygen-enriched water to the fed water/wastewater. The water can be separately discharged from the drain valve 16 or 17 when the water contained in the oxygen supply tank 1 or the biological activated carbon reactor 2 needs to be emptied.

3. Treatment Apparatus Using Biological Activated Carbon with a Recycled Oxygen-Enriched Water (Air-Lift Type)

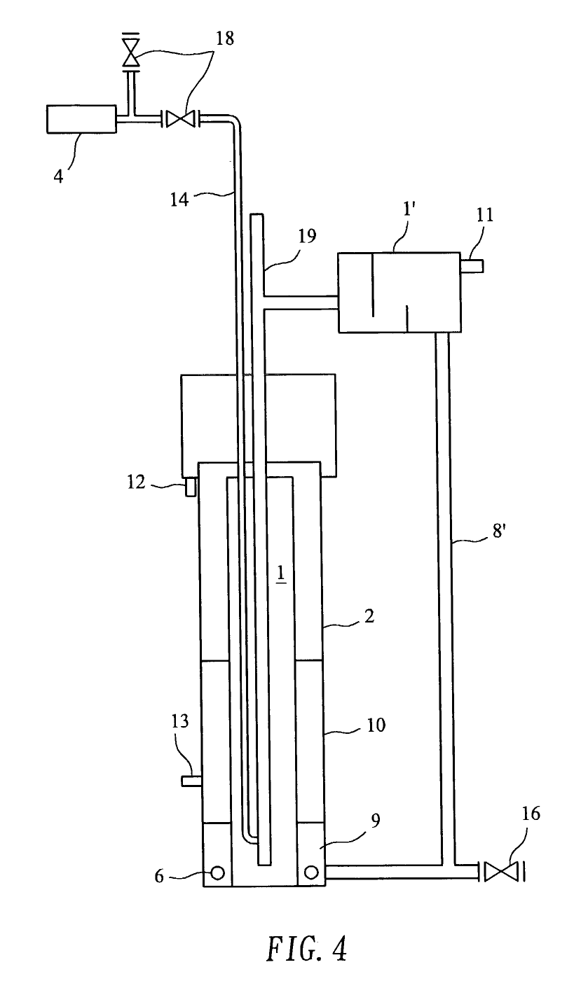

Referring to FIG. 1C and FIG. 4, the processing procedures for still another treatment apparatus using biological activated carbon with a recycled oxygen-enriched water according to the present invention comprises: feeding water/wastewater from an inlet pipe 11 to a metering tank 1′, where it is mixed with an oxygen-enriched water. The mixed water flows under gravity into a bottom of a biological activated carbon reactor 2 through a recycle pipe 8 and using a distribution pipe 6 at the bottom of the reactor 2 to uniformly distribute the water, which flow upwards through a support material 9 to expand the activated carbon bed 10, wherein the oxygen contained in the water/wastewater is used by the microorganisms attached on the activated carbon particles or suspended in the water for decomposing the organic contaminants adsorbed on the activated carbon or in the water. The amount of recycle water to expand the activated carbon while not flushing out the activated carbon particles is controlled by an air regulating valve 18. The oxygen-lean treated water which has flown through the activated carbon bed 10 is collected through a water collection overflow weir/trough 7, wherein a minor portion of the treated water is discharged through an outlet pipe 12 to a filter unit (not shown in the figures) for filtering out the suspended solids and discharging the filtered water, and a majority of the treated water overflows to the top of an oxygen supply tank 1. Air is pumped into an air-lift tube by using a blower 4 through an air pipe 14, so that oxygen is supplied to the treated water in the air-lift tube, and thus lifted to flow into the metering tank 1′. The exhausted activated carbon can be discharged from an outlet pipe 13 for waste activated carbon. The discharge amount of the waste activated carbon shall be determined experimentally. The amount of oxygen required in the removal of contaminants by the biological activated carbon can be adjusted by the amount of oxygen supplied by the blower 4. The water can be separately discharged from the drain valve 16 when the water contained in the oxygen supply tank 1 or the biological activated carbon reactor 2 needs to be emptied.

### EXPERIMENTAL EXAMPLES

The present invention was applied on the treatment of a wastewater from a paper mill, a wastewater from a pig farm, and a wastewater from a pesticide factory. Those types of wastewater had been treated by a biological wastewater treatment plant. Most of the contaminants that are easily decomposed by the microorganisms contained in the wastewater had been removed. A further treatment using the conventional biological technique on the above mentioned treated wastewater is difficult to be effective. However, this wastewater, after receiving a further treatment according to the present invention, can meet the newest standard of discharge water stipulated by the Republic of China on Taiwan in 1998.

### Example 1

### Wastewater from a Paper Mill

Scale of the experimental apparatus: 6 M³ pilot plant

Amount of wastewater treated: 35 M³/D

Quality of inlet water: secondary biologically treated water

COD concentration of the secondary biologically treated water: 120˜150 mg/L

COD concentration of the biological activated carbon treated water: <100 mg/L

Time of operation: 1 year

The flow rate ratio of the recycled oxygen-enriched water to the secondary biologically treated water is 10-20.

The concentration of dissolved oxygen in the water in the oxygen supply tank and the concentration of dissolved oxygen in the water in the discharged water are 6-7 mg/L and 0.5-1 mg/L, respectively.

### Example 2

### Wastewater from a Pig Farm

Scale of the experimental apparatus: 200 L pilot plant

Amount of wastewater treated: 1.5 M³/D

Quality of inlet water: secondary biologically treated water

COD concentration of the secondary biologically treated water: 250˜350 mg/L

COD concentration of the biological activated carbon treated water: <250 mg/L

Time of operation: 3 monthes

The flowrate ratio of the recycled oxygen-enriched water to the secondary biologically treated water is 10-20.

The concentration of dissolved oxygen in the water in the oxygen supply tank and the concentration of dissolved oxygen in the water in the discharged water are 6-7 mg/L and 0.5-1 mg/L, respectively.

### Example 3

### Wastewater from a Pesticide Factory

Scale of the experimental apparatus: 3.4 M³ full scale plant

Amount of wastewater treated: 35 M³/D

Quality of inlet water: secondary biologically treated water

COD concentration of the secondary biologically treated water: 150˜200 mg/L

COD concentration of the biological activated carbon treated water: <100 mg/L

Time of operation: 1 year

The flow rate ratio of the oxygen-enriched water to the secondary biologically treated water is 10-20.

The concentration of dissolved oxygen in the water in the oxygen supply tank and the concentration of dissolved oxygen in the water in the discharged water are 7-8 mg/L and 0.5-1 mg/L, respectively.

### Example 4

### Wastewater from a Fiber/Textile Dying Mill

Scale of the experimental apparatus: 1 M³ pilot plant (air-lift type)

Amount of wastewater treated: 5.7 M³/D

Quality of inlet water: biological activated carbon treated water

COD concentration of the influent water: 70˜100 mg/L

COD concentration of the biological activated carbon treated water: 20˜50 mg/L

Time of operation: 240 days

The flow rate ratio of the recycled oxygen-enriched water to the secondary biologically treated water is 15-25.

The concentration of dissolved oxygen in the water in the oxygen supply tank and the concentration of dissolved oxygen in the water in the discharged water are 6-6.5 mg/L and 4-4.5 mg/L, respectively.

From the abovementioned three examples, the present invention can be used to remove the organic contaminants contained in the secondary biologically treated water to the standard of a discharge water stipulated by the Republic of China on Taiwan in 1998. Its COD removal ratio is about 20˜50%.

In comparison with the conventional technique, the present invention has the following advantages:

1. A recycled oxygen-enriched water can increase the content of oxygen dissolved in the water in the biological activated carbon thereby increasing the removal efficiency of contaminants. In general, the COD removal concentration can reach 50˜100 mg/L, and the COD removal ratio can reach 20˜50%.

2. (1) The present invention adopts expanding of the activated carbon bed. There is no need of installing a pre-filtration facility. (2) The present invention adopts recycled oxygen-enriched water to suspend the particles of the activated carbon bed, instead of using an air-lifting tube. Therefore, the height of the unit can be reduced. (3) The packing ratio of the activated carbon can reach 60% thereby reducing the volume of the reactor. Therefore, the present invention has a lower engineering installation cost than the conventional technique.

3. The present invention adopts the recycled water to expand the activated carbon bed and reduce the wearing and loss of the particles, thereby reducing the consumption of the activated carbon and the operation cost of the process.

To sum up, the present invention meets the requirements of a patent and is submitted for a patent application according to the law.

1. A method of wastewater treatment using biological activated carbon with recycled oxygen-enriched water, which comprises the following steps:
a) introducing a to-be-treated wastewater into an oxygen supply tank, where an aeration with air or an oxygen-enriched gas is carried out, so that an oxygen-enriched water is formed;
b) introducing the oxygen-enriched wastewater from Step (a) into a bottom of a reactor containing a biological activated carbon bed, so that said biological activated carbon bed is expanded and a treated wastewater is formed in an upper portion of the reactor;
c) filtering and discharging a portion of the treated wastewater, and recycling another portion of the treated wastewater to said oxygen supply tank for performing aeration with said to-be-treated wastewater.

2. A method of wastewater treatment using biological activated carbon with recycled oxygen-enriched water, which comprises the following steps:
a) introducing a to-be-treated wastewater into an upper portion of a reactor containing a biological activated carbon bed, where the to-be-treated wastewater is mixed with a treated wastewater in said reactor;
b) introducing the mixed water from the upper portion of the reactor in Step (a) into an oxygen supply tank for aeration with air or an oxygen-enriched gas, so that an oxygen-enriched water is formed in the oxygen supply tank;
c) filtering and discharging a portion of the oxygen-enriched water in the oxygen supply tank, and recycling another portion of the oxygen-enriched water in the oxygen supply tank to a bottom of said reactor, so that said biological activated carbon bed is expanded.

3. The method as claimed in claim 1, wherein the biological activated carbon bed is supported at a position located at a distance from the bottom of said reactor, and said oxygen-enriched water is introduced into said reactor between the bottom of said reactor and said support position.

4. The method as claimed in claim 2, wherein the activated carbon bed is supported at a position located at a distance from the bottom of said reactor, and said another portion of the oxygen-enriched water is recycled into said reactor between the bottom of said reactor and said support position.

5. The method as claimed claim 1, wherein said another portion of the treated wastewater recycled to said oxygen supply tank has a flow rate which is 8-30 times of that of the to-be-treated wastewater introduced into the oxygen supply tank.

6. The method as claimed claim 3, wherein said another portion of the treated wastewater recycled to said oxygen supply tank has a flow rate which is 8-30 times of that of the to-be-treated wastewater introduced into the oxygen supply tank.

7. The method as claimed claim 2, wherein said another portion of the oxygen-enriched water recycled to said reactor has a flow rate which is 8-30 times of that of the to-be-treated wastewater introduced into the reactor.

8. The method as claimed claim 4, wherein said another portion of the oxygen-enriched water recycled to said reactor has a flow rate which is 8-30 times of that of the to-be-treated wastewater introduced into the reactor.

9. A wastewater treatment apparatus using biological activated carbon with recycled oxygen-enriched water comprising two sets of units, wherein one set is a biological activated carbon unit and the other set is an oxygen supply unit; and a recycle means; wherein
said biological activated carbon unit comprises a tank as a reactor, the interior of which, in the order from the bottom thereof, being installed with a distribution pipe, a support material and a water collection overflow means, an activated carbon capable of being disposed between said support material and said water collection overflow means;
said oxygen supply unit comprises an oxygen supply tank and an aeration means for supplying air or an oxygen-enriched gas into said oxygen supply tank;
wherein said water collection overflow means is for introducing a liquid inside said reactor into said oxygen supply tank; and
said recycle means is for supplying the aerated liquid inside said oxygen supply tank to said distribution pipe of said reactor.

10. The wastewater treatment apparatus as claimed in claim 9, wherein said biological activated carbon unit and said oxygen supply unit are connected in parallel, wherein the reactor of said biological activated carbon unit and the oxygen supply tank of said aeration unit share a common wall, and a hole is provided on the common wall near said water collection overflow means for allowing the liquid in the reactor of said biological activated carbon unit to flow into the oxygen supply tank of said aeration unit.

11. The wastewater treatment apparatus as claimed in claim 10 further comprising a baffle provided in the hole for preventing the liquid inside the oxygen supply tank of said oxygen supply unit from entering the reactor of said biological activated carbon unit.

12. The wastewater treatment apparatus as claimed in claim 9, wherein said biological activated carbon unit and said oxygen supply unit are separated, wherein the reactor of said biological activated carbon unit and the oxygen supply tank of said oxygen supply unit are installed separately, and a pipeline connects the reactor of said biological activated carbon unit at a position near said water collection overflow means to the oxygen supply tank of said oxygen supply unit for introducing the liquid from said reactor to said oxygen supply tank.

13. The wastewater treatment apparatus as claimed in claim 12, wherein said oxygen supply unit is positioned lower than said biological activated carbon unit, so that the liquid inside said reactor can be introduced into said oxygen supply tank from said water collection overflow mechanism without the need of using a mechanical power.

14. The wastewater treatment apparatus as claimed in claim 9, wherein said aeration means comprises an air diffuser installed inside said oxygen supply tank, and a blower or an air compressor installed outside said oxygen supply tank, wherein said blower or air compressor supplies air or an oxygen-enriched gas to said air diffuser and into said oxygen supply tank.

15. The wastewater treatment apparatus as claimed claim 9, wherein said aeration means comprises a submerged aeration apparatus installed in said oxygen supply tank for supplying air or an oxygen-enriched gas to said oxygen supply tank.

16. The wastewater treatment apparatus as claimed in claim 9, wherein said recycle means comprises a recycle pipeline connecting said oxygen supply tank to said distribution pipeline of the reactor; and a land-type or submerged-type pump installed on said recycle pipeline.

17. The wastewater treatment apparatus as claimed in claim 9 further comprising a filter for filtering the liquid discharged from said oxygen supply tank or said reactor.

18. A method of wastewater treatment using biological activated carbon with recycled oxygen-enriched water comprising the following steps:
a) introducing a to-be-treated wastewater into a metering tank to mix with an oxygen-enriched water, and introducing the resulting mixed water into a bottom of a reactor containing a biological activated carbon bed by gravity, so that said biological activated carbon bed is expanded and a treated wastewater is formed in an upper portion of the reactor;
b) filtering and discharging a portion of the treated wastewater from Step (a), and recycling another portion of the treated wastewater from Step (a) to an oxygen supply tank having an air-lift tube, wherein said air-lift tube is connected to said metering tank at an upper end thereof; and
c) pumping air or an oxygen-containing gas into a bottom end of said air-lift tube, so that said oxygen-enriched water is formed in said air-lift tube and lifted into said metering tank.

19. The method according to claim 18, wherein said reactor has an annular construction having an inner wall and an outer wall, and said biological activated carbon bed is packed between said inner wall and said outer wall and near the bottom of said annular construction; wherein said oxygen supply tank is located at a position confined by said inner wall of said annular construction of said reactor.

20. The method according to claim 19, wherein said oxygen supply tank is formed with said inner wall, and said inner wall has a height lower than that of said outer wall of said annular construction.
